(19) United States
(12) Patent Application Publication
(10) Pub. No.: US 2009/0007626 A1
(43) Pub. Date: Jan. 8, 2009

(54) Adjusting Element

(75) Inventors: Marian Bochen, Eitelborn (DE); Thomas Ehre, Koblenz (DE); Rolf Mintgen, Thuer (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/214,433

(22) Filed: Jun. 19, 2008

(30) Foreign Application Priority Data
Jun. 20, 2007 (DE) 10 2007 028 827.3

(51) Int. Cl. G01L 27/00

(52) U.S. Cl. 73/1.68; 73/1.72

(57) ABSTRACT

An adjusting element with a cylinder which is closed at one end and filled with a fluid under pressure, wherein a piston which is displaceable axially in the cylinder divides the cylinder into a first work space and a second work space, and a piston rod is arranged at one side of the piston and guided out of the other end of the cylinder through the first work space in a sealed manner by a sealing and guiding device. The adjusting element has a measuring device for detecting the piston rod position and the length of extension of the adjusting element.

### BACKGROUND OF THE INVENTION

1. Field of the Invention

The invention is directed to an adjusting element with a cylinder which is closed at one end and filled with a fluid under pressure, with a piston which is displaceable axially in the cylinder and which divides the cylinder into a first work space and a second work space, and with a piston rod which is arranged at one side of the piston and is guided out of the other end of the cylinder through the first work space in a sealed manner by a sealing and guiding device.

2. Description of the Related Art

It is known to use an adjusting element including a piston-cylinder unit in trunk hoods or trunk covers and engine hoods in motor vehicles to ensure a convenient automatic or manual opening and closing thereof. In particular, when the hoods are opened and closed automatically, it can be advantageous to detect the position of the piston and accordingly the position of the piston rod relative to the piston-cylinder unit to fulfill certain functions at set points along the lifting path of the piston-cylinder unit.

### SUMMARY OF THE INVENTION

It is therefore an object of the invention to provide an adjusting element which fulfills the above-mentioned functions through the implementation of steps which minimize installation space.

These and other objects and advantages are achieved by an adjusting element having a measuring device for detecting the piston rod position and/or the extension length of the adjusting element.

In accordance with the invention, and in an inexpensive construction which economize on installation space, the measuring device comprises a membrane potentiometer which is arranged at the cylinder and extends in an axial direction on the outer side of the cylinder. Here, the piston is provided with a contact strip and a resistance strip to measure the path traveled by the piston using voltage ratios. A reference voltage is applied to the contact strip, a ground potential is applied to one side of the resistance strip, and a positive voltage potential is applied to the other side of the resistance strip.

Reliable operation is ensured by a dual sliding contact which is movable over the membrane potentiometer so that a moving lead for registering the voltage can be eliminated. In addition, malfunctions can be prevented by arranging the dual sliding contact in a protective tube.

In an alternative embodiment, the measuring device comprises a magnetic tape that is arranged at the cylinder and extends in the axial direction on the outer side of the cylinder. Here, the magnetic tape is provided with segments which are oppositely polarized in an alternating manner along the axial direction of the magnetic tape.

The measuring device comprises a non-contacting Hall sensor that is movable over the magnetic tape so that a construction is provided which is impervious to weather and free from wear and which operates very precisely and reliably.

To ensure reliable detection of the movement direction, the Hall sensor comprises two sensors. The mechanical reliability vis-à-vis mechanical influences is additionally increased by arranging the Hall sensor in a protective tube.

In an alternative embodiment, the measuring device comprises two magnetic tapes which are arranged at the cylinder and extend in the axial direction on the outer side of the cylinder. A simple assembly is thus achieved by arranging the two magnetic tapes on a common carrier material. Here, the magnetic tapes have segments which are polarized out of phase in the axial direction of the magnetic tapes. Moreover, the segments of one magnetic tape are arranged such that they are offset in phase in the axial direction relative to the segments of the second magnetic tape to ensure reliable detection of the movement and a detection of absolute values. As a result, a construction is achieved which is impervious to weather and free from wear and which is highly accurate and reliable, because the measuring device comprises two magnetic resonance (MR) sensors which are movable in a non-contacting manner over the magnetic tapes, and each MR sensor is associated with a magnetic tape. Consequently, it becomes possible to detect the absolute value of the path of the thus constructed piston/piston rod unit. Here, the MR sensors are arranged in a protective tube to reduce mechanical influences.

In an alternative embodiment, the measuring device comprises a coil arranged at the cylinder, where the ends of the coil are connected to a control device. Here, the measuring device comprises a plunger armature which is displaceable in the coil to ensure a non-contacting operation which is therefore free from wear and resistant to dirt. As a result, a simple construction is provided because the plunger armature is fastened to the free end of the piston rod and can be displaced with the piston rod.

In an alternative embodiment, the measuring device comprises a light transmitting device, a light receiving device and a reflector so that a noncontacting and therefore low-wear construction is provided.

In another alternative embodiment, the light transmitting device and light receiving device are arranged at the free end of the piston rod and the reflector is arranged at the closed end of the cylinder. The light transmitting device and light receiving device are arranged at a defined distance from one another. In addition, the light receiving device has a sensor comprising at least one photodiode.

In another alternative embodiment, the measuring device comprises a metal plate. Here, the metal plate forms a first electrode of a capacitor and the cylinder forms a second electrode of a capacitor to economize on installation space and provide an inexpensive construction.

Moreover, installation space is advantageously utilized by arranging the metal plate at the free end of the piston rod and by permitting the metal plate to move past the cylinder at a distance from the cylinder wall. The required installation space is thus kept small because the protective tube is fixed to the piston rod and at least partially surrounds both the piston rod and the cylinder.

In an alternative embodiment, the measuring device comprises a microwave transmitting and receiving unit.

An embodiment that is particularly economical with respect to installation space is achieved by arranging the microwave transmitting and receiving unit in the cylinder. Such an arrangement of the microwave transmitting and receiving unit in the cylinder at its closed end provides a device that operates in a particularly reliable manner.

Alternatively, the microwave transmitting and receiving unit can be arranged in the cylinder at its sealing and guiding assembly to further economize on the installation space. Here, a control device comprising evaluating electronics is associated with the measuring device.

In one particular embodiment, the piston that is inserted in the cylinder comprises a magnetic valve that is controlled by the control device. Here, extended length of the piston rod, and therefore its position, is detected by the measuring device and is conveyed to the control device which evaluates the signals and accordingly controls the magnetic valve.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiment examples of the invention are shown in the drawings and are described more fully in the following.

FIG. 1 shows a cross-sectional view of the adjusting element in accordance with the invention;

FIG. 2 shows a detailed cross-sectional view of the adjusting element of FIG. 1;

FIG. 3 shows another cross-sectional view of the adjusting element in accordance with an embodiment of the invention;

FIG. 4 shows a detailed cross-sectional view of the adjusting element of FIG. 3;

FIG. 5 shows another cross-sectional view of the adjusting device in accordance with another embodiment of the invention;

FIG. 6 shows a detail cross-sectional view adjusting device of FIG. 5;

FIG. 7 shows a cross-sectional view of the adjusting device in accordance with another embodiment of the invention;

FIG. 8 shows a cross-sectional view of the adjusting device in accordance with another embodiment of the invention;

FIG. 9 shows a detail cross-sectional view of the adjusting device of FIG. 8;

FIG. 10 shows a cross-sectional view of the adjusting device in accordance with another embodiment of the invention; and

FIG. 11 shows a cross-sectional view of the adjusting device in accordance with a further embodiment of the invention.

### DETAILED DESCRIPTION OF THE PRESENTLY PREFERRED EMBODIMENTS

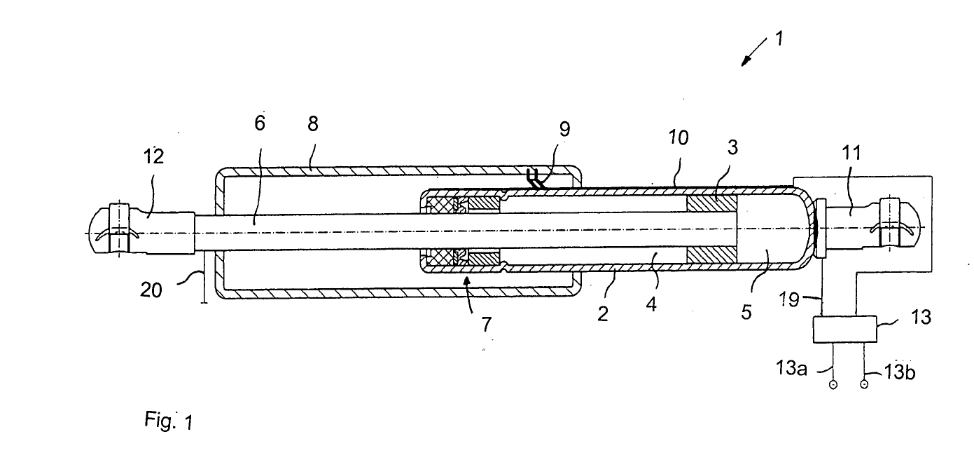

FIG. 1 shows an adjusting element 1 with a hollow cylinder 2 which is closed at one end and filled with a fluid under pressure, a piston 3 which is displaceable axially in the cylinder 2 and divides the cylinder 2 into a first work space 4 and a second work space 5. A piston rod 6 is arranged at one side of the piston 3 and is guided out of the other end of the cylinder 2 through the first work space 4 in a sealed manner by a sealing and guiding device 7. Further, the piston has a magnetic valve, not shown, which can be controlled electrically to open or close to allow or prevent a flow of fluid through the piston 3. When the magnetic valve is open, fluid is allowed to flow from one work chamber to the other, and the piston 3 and piston rod 6 can move in the axial direction in the cylinder 2. When the magnetic valve is closed, fluid is prevented from flowing from one work chamber to the other and the piston 3 is locked.

A protective tube 8 is arranged at the end of the piston rod 6 located opposite to the piston 3 and is fixed with respect to rotation. The protective tube 8 and the piston rod 6 are electrically insulated. A dual sliding contact 9 is located inside the protective tube 8, and a membrane potentiometer 10 is arranged on the outer side of the cylinder 2. The two sliding contacts of the dual sliding contact 9 are connected to one another so as to be electrically conducting. There is no electrically conducting connection between the membrane potentiometer 10 and the cylinder 2. The dual sliding contact 9 moves over the membrane potentiometer 10. The piston rod 6 and the cylinder 2 are electrically insulated from one another.

A first connection element 11 is arranged at the closed end of the cylinder 2 and a second connection element 12 is arranged at the end of the piston rod 6 located opposite to the piston 3. By means of these connection elements 11, 12, the adjusting element can be fitted, for example, to a body of a motor vehicle and to a gate, particularly a tailgate, that is swivelably arranged at the body.

The dual sliding contact 9 arranged at the protective tube 8 moves over the membrane potentiometer 10 extending in the axial direction at the cylinder. The path that is traveled is calculated by using voltage ratios. The evaluation is performed by a microcontroller (not shown) which is arranged in a control device 13 having first contact 13a and second contact 13b. A dual sliding contact is used so that movable cables can be dispensed with in the membrane potentiometer 10. The skilled person will appreciate that it is also possible to use a single sliding contact as a potentiometer and to calculate the path using the voltage splitter with the help of the microcontroller. Membrane potentiometers which respond to pressure, are impervious to soiling and have reduced wear during operation can preferably be used.

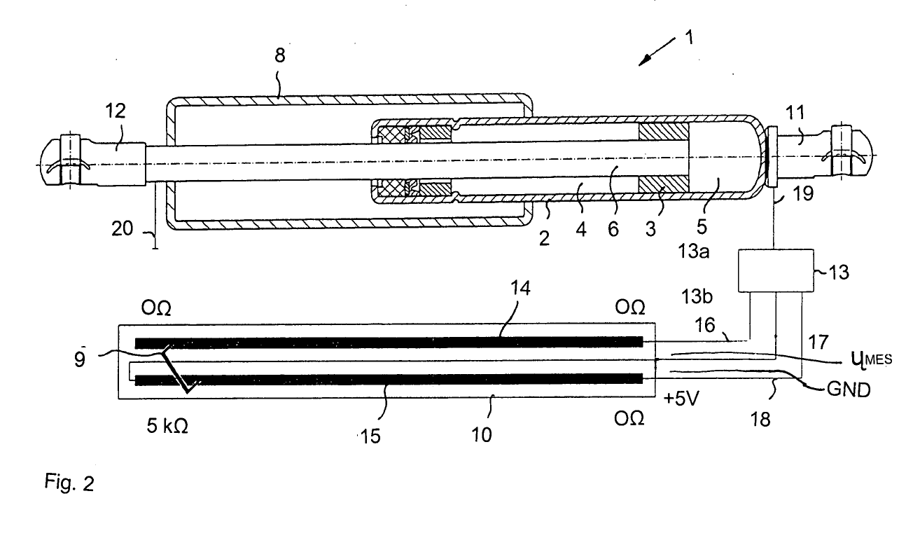

FIG. 2 shows an electric wiring diagram for the membrane potentiometer 10, the control device 13 and the adjusting element 1. The membrane potentiometer has a contact strip 14 and a resistance strip 15. The contact strip has an electrical resistance of almost 0 ohms over its entire length. A line 16 leads from one end of the contact strip 14 to the control device 13, and the reference voltage is applied to line 16. The resistance strip 15 has a resistance which changes substantially continuously from 0 ohms to a value of several thousand ohms, preferably 5 kilo ohms, from one end to the other. The two ends of the resistance strip 15 are likewise connected to the control device 13 by a line 17 and 18, respectively. Preferably, 5 volts are present at one line and the other line is connected to ground. A line 19 with positive potential leads from the control device to the cylinder 2 of the adjusting element 1. A terminal 20 connected to the piston rod 6 is connected to ground. However, it is also possible that the terminal 20 is guided into the control device 13. A voltage or positive potential is present at line 19, preferably the supply voltage of the motor vehicle which is sufficiently large enough to reliably actuate the magnetic valve. The control device has a first terminal 13a and a second terminal 13b by which it can likewise be connected to the vehicle power supply (see FIG. 1).

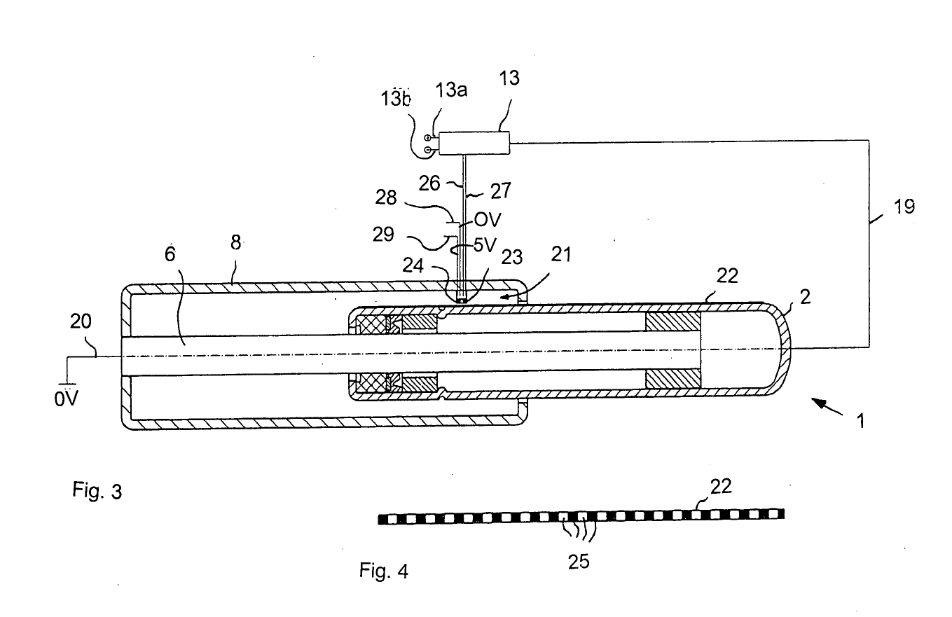

FIG. 3 shows another embodiment of the invention which substantially corresponds to the embodiment form shown in FIG. 1. Therefore, corresponding structural component parts are provided with the same reference numbers used in FIGS. 1 and 2. This also applies to all other drawings described in the following.

In contrast to the adjusting element of the first embodiment, a Hall sensor 21 is located in the protective tube 8 and a magnetic tape 22 is arranged on the outer side of the cylinder 2. The Hall sensor 21 has two sensors 23 and 24 which are arranged so as to be out of phase at a determined angle, preferably 40°. When the piston rod 6 is moved, the Hall sensor 21 is moved over the magnetic tape 22 without contacting by the protective tube 8. The magnetic tape 22 has a plurality of segments 25 which are differently magnetized, i.e., the north and south poles alternate continuously. The Hall sensor 21 counts the differently magnetized increments. The path distance is calculated by evaluating electronics in the control device 13. The two sensors 23 and 24 are electrically connected to the control device 13 by lines 26 and 27. Terminals 28 and 29 of the two sensors 18 and 19 can be connected to a separate supply voltage or to the control device 13. A voltage by which the magnetic valve can be actuated is applied in turn to the line 19 guided to the cylinder 2. The control device has a first terminal 13a and a second terminal 13b by which it can be connected to the vehicle power supply. The piston rod 6 is connected to ground potential by terminal 20.

FIG. 4 shows the construction of the magnetic tape 22 with its alternately arranged magnetized or magnetic segments 25.

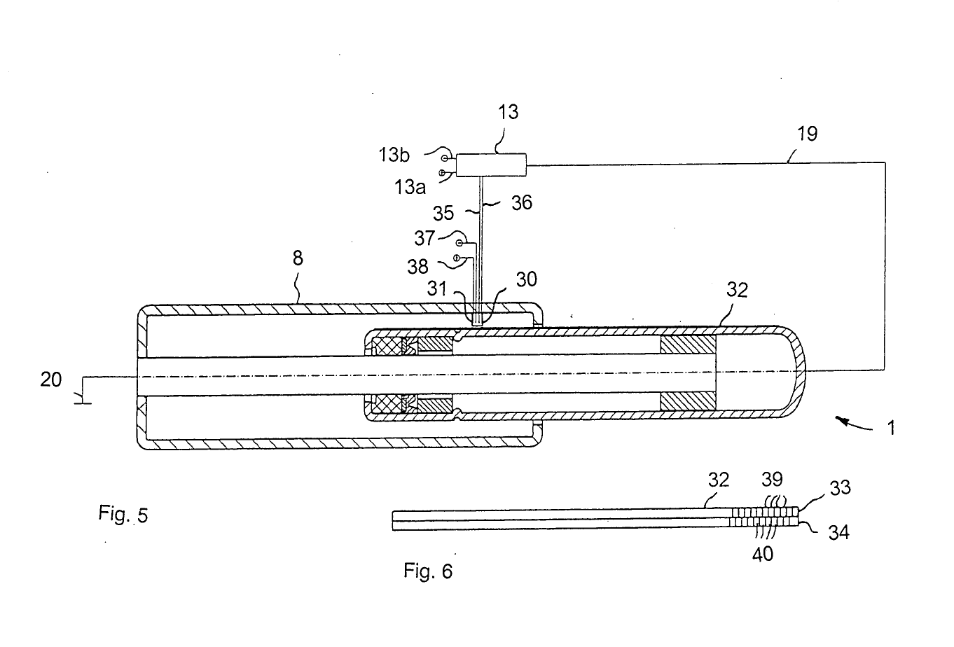

An alternative embodiment of the invention is shown in FIG. 5. Two magnetoresistive sensors, designated as magnetic resonance (MR) sensors 30 and 31, are arranged in the protective tube 8. These MR sensors 30 and 31 can be moved in a non-contacting manner over a magnetic strip 32 with a first magnetic tape 33 and a second magnetic tape 34. The MR sensors 30 and 31 are connected to the control device 13 by lines 35 and 36. The terminals 37 and 38 of the two MR sensors 30 and 31 can be connected to a separate supply voltage or to the control device 13. The first and second magnetic tapes 33 and 34 both have a plurality of segments 39 and 40 which provide a phase displacement in the axial direction of the magnetic tapes which results in a cosine-shaped curve for the magnetic resistance. The segments 39 of the magnetic tape 33 are arranged in a phase offset in axial direction relative to the segments 40 of the second magnetic tape 34. A respective MR sensor is associated with each of the magnetic tapes so that an absolute path detection is possible. A voltage by which the magnetic valve can be actuated is applied to the line 19 which is guided to the cylinder 2. The control device has a first terminal 13a and a second terminal 13b which can be connected to the vehicle power supply. The piston rod 6 is connected to ground potential by terminal 20.

FIG. 6 shows the construction of the magnetic strip with its magnetic tapes 33 and 34 which extend in the axial direction and which have a plurality of segments 39 and 40 providing a phase displacement in the axial direction of the magnetic tapes.

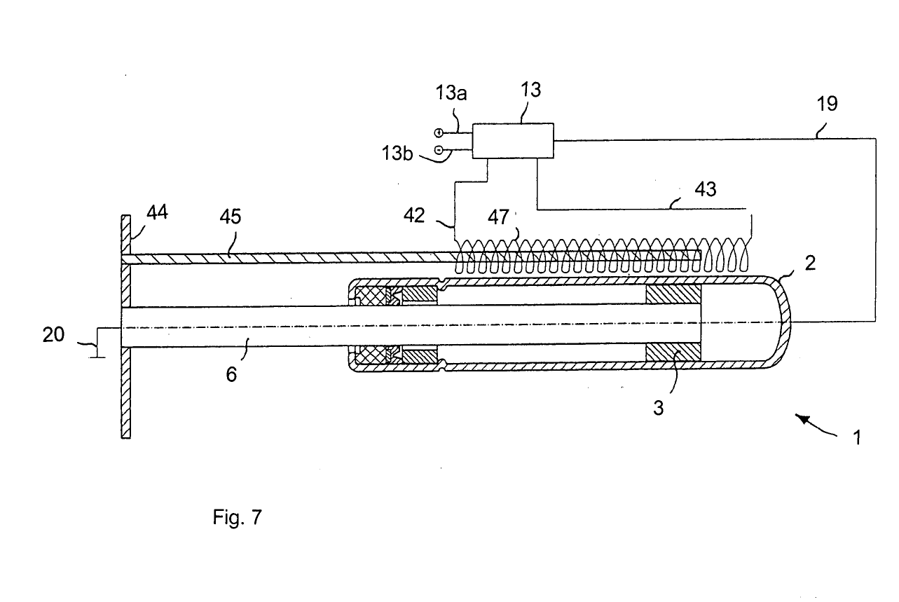

The embodiment shown in FIG. 7 shows a coil 41 which extends in the axial direction alongside the cylinder 2 and which is connected to the control device 13 by two lines 42 and 43. A holding device 44 is arranged at the end of the piston rod 6 opposite the piston 3, a plunger armature 45 of soft iron extending therefrom into the coil 41. The holding device 44 and piston rod 6 are electrically insulated. There is no electrically conducting connection between the coil 41 and the cylinder 2. The piston rod 6 and cylinder 2 are likewise electrically insulated. The plunger armature 45 can be inserted into the coil 41 as core material when the piston rod 6 is moved into the cylinder 2.

Accordingly, the plunger armature 45 moves in proportion to the piston movement and changes the inductance in the coil 41. The path is determined by an RC oscillating circuit (not shown). Changing the inductance of the coil 41 changes the oscillating frequency of the circuit. The traveled path can be determined by a microcontroller which is arranged, for example, in the control device 13. The magnetic valve arranged in the piston 3 is controlled by the control device 13 via the line 20. The piston rod 6 is connected to ground potential by terminal 20.

A protective tube which at least partially surrounds the plunger armature 45, the coil 41 and the cylinder 2 can be arranged at the holding device 44 in accordance with the contemplated embodiments described above.

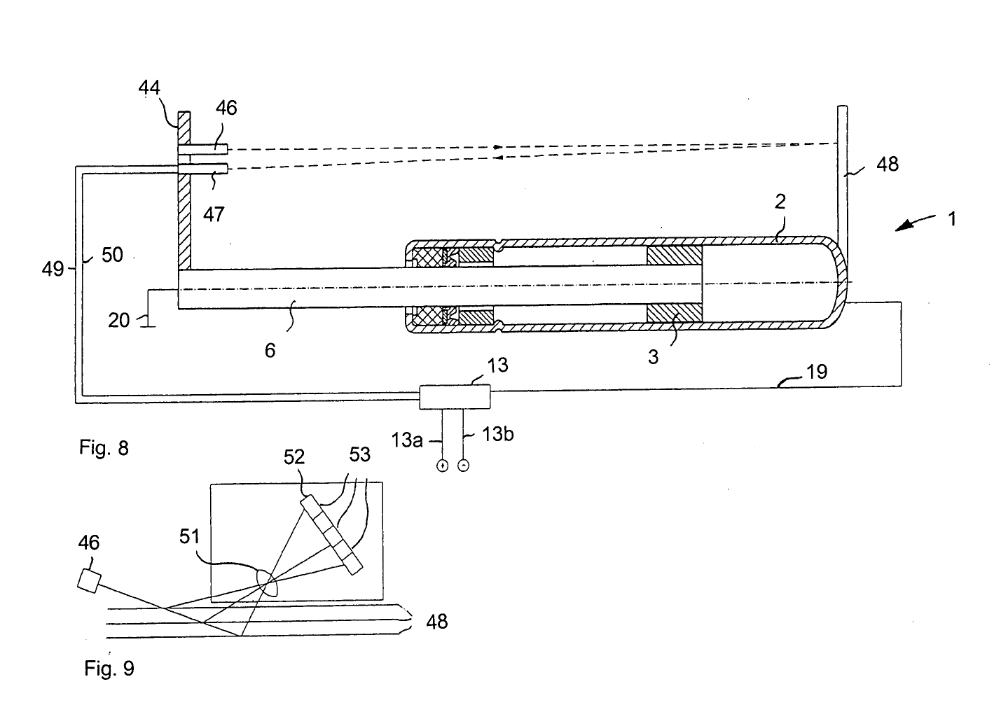

An alternate embodiment in which the path is determined by triangulation or a pulse propagation time measurement is shown in FIG. 8. Here, the holding device 44 is arranged at the end of the piston rod 6 located opposite to the piston 3, a light transmitting device 46 in the form of a laser diode and a light receiving device 47 is arranged at the holding device 44. A reflector 48 which faces toward the light transmitting device 46 and light receiving device 47 is arranged at the closed end of the cylinder 2. The light receiving device 47 is connected to the control device 13 by two lines 49 and 50. The piston rod 6 is connected to ground potential by terminal 20 and the cylinder 2 is connected to the control device 13 by line 19.

In pulse propagation time measurement, the light transmitting device 46 emits optical pulses which are reflected by the reflector 48 and enter the light receiving device 47. The path is calculated from the difference in propagation time between the transmitted pulse and the received pulse by a microcontroller which is accommodated in the control device. The control device 13 controls the magnetic valve via line 20.

For path measurement using triangulation, the light transmitting device 46 sends a light beam to the reflector 48. The light is reflected by the reflector 48 and is detected by the light receiving device 47 in that, as is shown schematically in FIG. 9, the received light is focused by a lens 51 and is evaluated on a sensor 52 with a series of photodiodes 53. The position of the piston rod 6 can be derived from the photodiodes 53 that are illuminated at a specific point in time. Since the movement of the piston rod 6 is proportional to the movement of the light transmitting device 46, the piston rod position can be determined form the distance of the light transmitting device 46 from the reflector 48. A microcontroller which can again be arranged in the control device 13 is required for calculating the distance.

In accordance with the contemplated embodiments, a protective tube enclosing the light transmitting device 46, the light receiving device 47 and, at least partly, the cylinder 2 or reflector 48 can be arranged at the holding device 44.

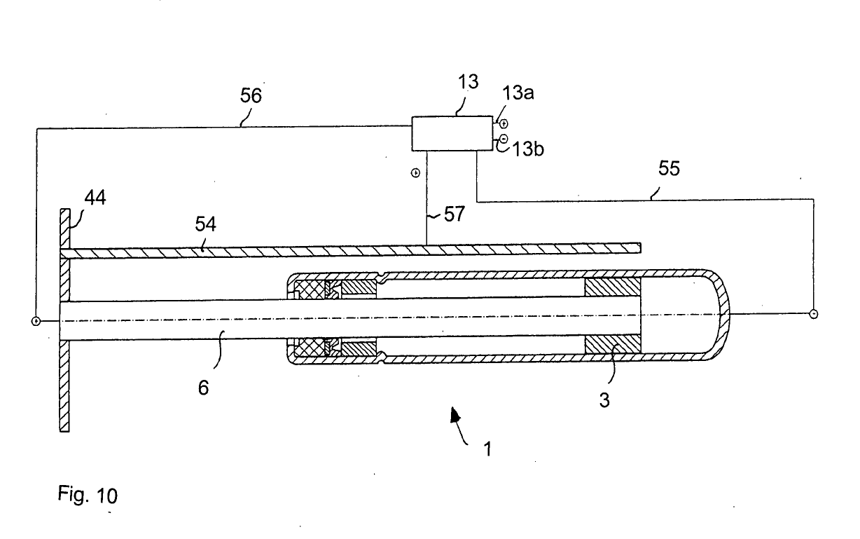

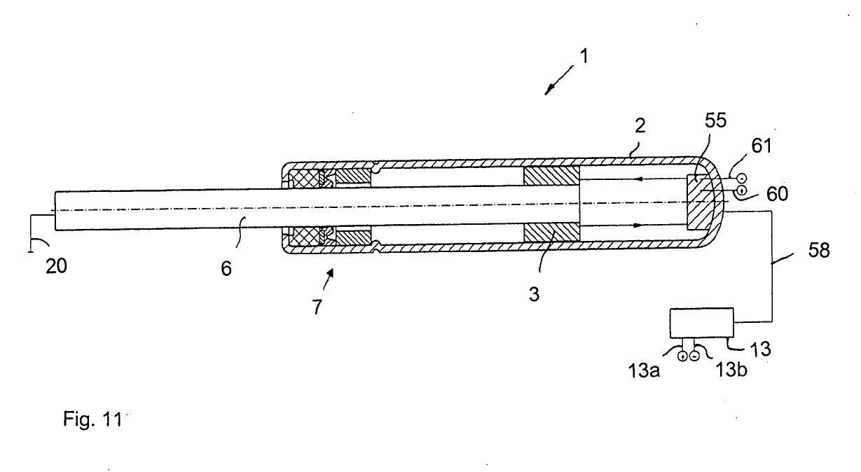

A capacitive path measurement is shown in FIG. 10. Here, a metal plate 54 extending in the direction of the cylinder 2 at a defined radial distance therefrom is arranged at the end of the piston rod 6 located opposite to the piston 3 at the holding device 44. The holding device 44 and the piston rod 6 are electrically insulated. Also, there is no electrically conducting connection between the piston rod 6 and the cylinder 2.

The cylinder 2 is connected, for example, by a line 55 to ground potential, the piston rod 6 is connected to the supply voltage or to a positive potential by a line 56, and a positive potential, for example, the supply voltage or another voltage having a different value, is applied to the metal plate 54. This can be carried out by a line 57 from the control device 13. In this way, a capacitance is formed between the cylinder 2 and the metal plate 54. The movement of the piston rod 6 provides for an equivalent movement of the metal plate 54. In this way, the capacitance between the cylinder 2 and the metal plate 54 changes. The traveled path can be calculated by a microcontroller based on the change in capacitance.

In accordance with the contemplated embodiments, a protective tube which at least partly surrounds the metal plate 54 and the cylinder 2 can be arranged at the holding device 44.

FIG. 11 shows an adjusting element 1 and a microwave transmitting and receiving unit 58 accommodated within its cylinder 2. In the contemplated embodiment shown in FIG. 11, the microwave transmitting and receiving unit 58 is arranged at the closed end of the cylinder 2. The microwave transmitting and receiving unit 58 is connected to the control 13 by lines 59 and 60. A line 61 with positive potential leads from the control to the cylinder 2 so that the magnetic valve can be controlled. The piston rod is connected to ground potential by terminal 20 either directly or via the control device 13. The microwave transmitting and receiving unit 58 is connected to the vehicle power supply either directly by terminals 61 and 62 or by the control device 13.

The transmission part of the microwave transmitting and receiving unit 58 sends an electromagnetic wave in the GHz range into the waveguide structure of the cylinder 2 by an antenna. This wave is reflected at the piston 3 and is again received by the same antenna. The signal that is coupled in and the received signal are compared with respect to their phase displacement. The process is repeated at different frequencies. The absolute position of the piston 3 is determined by a microcontroller. When the piston 3 moves, the phase displacement changes so that the actual position can be calculated.

It should be noted, however, that it is also conceivable to arrange the microwave transmitting and receiving unit 55 in the piston 3 or in the sealing and guiding assembly 7.

Naturally, the separate lines shown in the drawings can be replaced by bus lines which can at least connect a control device to the different structural component parts for supplying voltage and transmitting signals.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. Adjusting element comprising:
a cylinder which is closed at one end and filled with a fluid under pressure;
a piston which is displaceable axially in the cylinder and which divides the cylinder into a first work space and a second work space;
a piston rod which is arranged at one side of the piston and guided out of another end of the cylinder through the first work space in a sealed manner by a sealing and guiding device; and
a measuring device for detecting at least one of the piston rod position and a length of extension the adjusting element.

2. The adjusting element according to claim 1, wherein the measuring device comprises a membrane potentiometer which is arranged at the cylinder.

3. The adjusting element according to claim 2, wherein the membrane potentiometer extends in an axial direction on an outer side of the cylinder.

4. The adjusting element according to claim 3, wherein the membrane potentiometer has a contact strip and a resistance strip, wherein a reference voltage is applied to the contact strip, a ground potential is applied to one side of the resistance strip and a positive voltage potential is applied to another side of the resistance strip.

5. The adjusting element according to claim 1, wherein the measuring device comprises a dual sliding contact which is movable over the membrane potentiometer.

6. The adjusting element according to claim 5, wherein the measuring device includes a protective tube, the dual sliding contact being arranged in the protective tube.

7. The adjusting element according to claim 1, wherein the measuring device comprises a magnetic tape which is associated with the cylinder.

8. The adjusting element according to claim 7, wherein the magnetic tape extends in an axial direction on the outer side of the cylinder.

9. The adjusting element according to claim 8, wherein the magnetic tape has segments which are oppositely polarized alternately in an axial direction of the magnetic tape.

10. The adjusting element according to one of claim 7, wherein the measuring device comprises a non-contacting Hall sensor that is movable over the magnetic tape.

11. The adjusting element according to claim 10, wherein the Hall sensor comprises two sensors.

12. The adjusting element according to one of claim 10, wherein the Hall sensor is arranged in a protective tube.

13. The adjusting element according to claim 1, wherein the measuring device comprises two magnetic tapes which are arranged at the cylinder.

14. The adjusting element according to claim 13, wherein the magnetic tapes extend in and axial direction on an outer side of the cylinder.

15. The adjusting element according to claim 13, wherein the two magnetic tapes are arranged on a common carrier material.

16. The adjusting element according to one of claim 13, wherein the two magnetic tapes have segments which are polarized out of phase in an axial direction of the magnetic tapes.

17. The adjusting element according to claim 16, wherein the segments of one magnetic tape are arranged so as to be offset in phase in an axial direction relative to the segments of the second magnetic tape.

18. The adjusting element according to one of claim 13, wherein the measuring device comprises two magnetic resonance (MR) sensors which are movable over the magnetic tapes in a non-contacting manner, wherein each MR sensor is associated with a magnetic tape.

19. The adjusting element according to claim 18, wherein the MR sensors are arranged in a protective tube.

20. The adjusting element according to claim 1, wherein the measuring device comprises an inductive coil arranged at the cylinder.

21. The adjusting element according to claim 20, wherein ends of the coil are connected to a control device.

22. The adjusting element according to one of claim 20, wherein the measuring device comprises a plunger armature which is displaceable in the coil.

23. The adjusting element according to claim 22, wherein the plunger armature is fastened to a free end of the piston rod and is displaceable with the piston rod.

24. The adjusting element according to claim 1, wherein the measuring device comprises a light transmitting device, a light receiving device and a reflector.

25. The adjusting element according to claim 24, wherein the light transmitting device and light receiving device are arranged at a free end of the piston rod, and the reflector is arranged at the closed end of the cylinder.

26. The adjusting element according to claim 25, wherein the light transmitting device and light receiving device are arranged at a defined distance from one another.

27. The adjusting element according to claim 24, wherein the light receiving device has a sensor comprising at least one photodiode.

28. The adjusting element according to claim 1, wherein the measuring device comprises a metal plate.

29. The adjusting element according to claim 28, wherein the metal plate forms a first electrode of a capacitor and the cylinder forms a second electrode of the capacitor.

30. The adjusting element according to claim 28, wherein the metal plate is arranged at the free end of the piston rod and is moveable past the cylinder at a distance from a wall of the cylinder.

31. The adjusting element according to claim 6, wherein the protective tube is fixed to the piston rod and at least partially surrounds both the piston rod and the cylinder.

32. The adjusting element according to claim 1, wherein the measuring device comprises a microwave transmitting and receiving unit.

33. The adjusting element according to claim 32, wherein the microwave transmitting and receiving unit is arranged in the cylinder.

34. The adjusting element according to claim 32, wherein the microwave transmitting and receiving unit is arranged in the cylinder at the closed end of the cylinder.

35. The adjusting element according to claim 32, wherein the microwave transmitting and receiving unit is arranged in the cylinder at the sealing and guiding device.

36. The adjusting element according to claim 1, wherein a control device is associated with the measuring device.

37. The adjusting element according to claim 36, wherein the piston comprises a magnetic valve.

38. The adjusting element according to claim 37, wherein the magnetic valve is controlled by the control device.

39. The adjusting element according to claim 38, wherein the control device controls the magnetic valve based on signals detected by the measuring device.
